(19) United States
(12) Patent Application Publication
(10) Pub. No.: US 2002/0113817 A1
(43) Pub. Date: Aug. 22, 2002

(54) Communication network system

(76) Inventor: Tatsuya Mitsugi, Tokyo (JP)

Correspondence Address: BIRCH STEWART KOLASCH & BIRCH, PO BOX 747, FALLS CHURCH, VA, 22040-0747, US

(21) Appl. No.: 09/955,197

(22) Filed: Sep. 19, 2001

(30) Foreign Application Priority Data
Feb. 21, 2001 (JP) 2001-45526

(51) Int. Cl. G09G 5/00

(52) U.S. Cl. 345/744

(57) ABSTRACT

A communication network system includes a contents server disposed as a source of information, for storing contents information, a portal server, responsive to a request which a user makes through communication terminal equipment, for transmitting contents information to the communication terminal equipment, and a conversion/formatting server disposed between the contents server and the portal server, for converting contents information which the conversion/formatting server has acquired from the contents server into contents information in a predetermined format, formatting the contents information in the predetermined format into contents information suitable for display on the communication terminal equipment in response to a request from the portal server, and transmitting the formatted contents information to the portal server.

### BACKGROUND OF THE INVENTION

1. Field of the Invention

The present invention relates to a communication network system that employs a communication network as a distribution channel for contents information and that enables users to browse and confirm contents information, and to respond to contents information.

2. Description of the Prior Art

FIG. 6 is a block diagram showing the structure of a prior art communication network system disclosed in, for example, Japanese patent application publication No. 2000-20424. In the figure, reference numeral 100 denotes a computer system which is a transmitting end for transmitting information, reference numeral 101 denotes an application unit that executes an application and sends out information resulting from the execution of the application, reference numeral 102 denotes a storage unit for storing a database or the like which contains contents information, reference numeral 103 denotes a transmit unit for, in order to transmit information output by the application unit 101 as E-mail, converting it into information in the form of E-mail by using a class library 104, and reference numeral 105 denotes a mail interface unit that transmits the information in the form of E-mail to a specified destination by way of the Internet 200. Furthermore, reference numeral 300 denotes a computer system which is a receiving end for receiving information, reference numeral 305 denotes a mail interface unit that receives information in the form of E-mail by way of the Internet 200, reference numeral 303 denotes a receive unit that deciphers and preprocesses the information in the form of E-mail received by the mail interface unit 305 by using a class library 304 for delivery of the information to a step of postprocessing the information, and reference numeral 301 denotes an application unit that executes an application by using the received information preprocessed by the receive unit 303, and outputs information resulting from the execution of the application and stores it in a storage unit 302 if necessary.

In operation, in the computer system 100, the application unit 101 executes a certain application and delivers information resulting from the execution of the application to the transmit unit 103. The application can be an application that can retrieve required contents information by searching through a database stored in the storage unit 102 for the contents information, for example. The transmit unit 103 preprocesses the information from the application unit 101 by using the class library 104 so as to convert it into information in the form of E-mail so that the information from the application unit 101 can be sent out by way of the mail interface unit 105. The mail interface unit 105 transmits the information in the form of E-mail to the computer system 300 by way of the Internet 200. When the mail interface unit 305 receives the information in the form of E-mail by way of the Internet 200, the receive unit 303 deciphers the information in the form of E-mail by using the class library 304 and then converts it into information which the application unit 301 can handle. The application unit 301 executes a certain application by using the preprocessed, received information, and then outputs information resulting from the execution of the application and stores it in the storage unit 302 if necessary.

The computer system 100 can function as a contents server that provides contents information. On the other hand, the computer system 300 can function as a portal server that constructs a portal site, which serves as an entrance to the Internet 200.

Users can acquire desired information from many pieces of contents information which are spread out over the Internet 200 by accessing the computer system 300, which functions as a portal server, by way of the Internet 200 using one of a variety of communication terminal devices (not shown in the figure), such as a cellular phone or a personal computer (abbreviated as PC from here on).

A plurality of portal servers exist in the Internet 200, and therefore a user can select his or her favorite portal server. Therefore, portal servers should enhance their contents information to have the contents information accessed by a lot of users, and, in order to enhance the contents information, should access a variety of contents servers so as to acquire many pieces of contents information. The computer system 100, which functions as a contents server, stores contents information having a specific data structure in the storage unit 102. In response to a request from a portal server, the computer system 100 can transmit contents information to the portal server. Although the computer system 300, which functions as a portal server, can acquire such contents information directly from a contents server, it has to convert received contents information, which is written in a format that depends on the contents server, that is, which has a data structure specific to the contents server, into exchangeable contents information having a specific display format.

A problem with a prior art communication network system constructed as above is that contents servers have to convert contents information to be transmitted into contents information in a predetermined format and portal servers have to perform a format conversion, on contents information transmitted from a contents server, and therefore transmitting-side and receiving-side applications have to understand the attributes, elements, and structure of data which constitute contents information to be transmitted and received in advance. In other words, in order to allow use of a communication network, such as the Internet, as a distribution channel of contents information, and to enable users to browse, retrieve, and confirm any contents information, and respond to the contents information by using an identical method, both transmitting-side and receiving-side applications have to understand the data structure of contents information to be transmitted and received.

In addition, another problem with a prior art communication network system, in which a lot of portal servers, a lot of contents servers and various types of communication terminal equipment exist, is that format conversion performed in -portal servers or contents servers decreases the efficiency in information transfers for distribution of information, and, consequently, causes the communication network system to become rigid. A further problem is that since users can select their favorite portal servers, and therefore portal servers should enhance their contents information to have the contents information accessed by make a lot of users and should access a variety of contents servers so as to acquire many pieces of contents information for the purpose of enhancing the contents information, the load of the format conversion increases and hence the efficiency in information transfers for distribution of information is further reduced.

### SUMMARY OF THE INVENTION

The present invention is proposed to solve the above-mentioned problems, and it is therefore an object of the present invention to provide a communication network system in which functions of converting each contents information having a format which depends on a contents server into contents information having a predetermined format which can be exchanged by way of a communication network, and formatting the resultant contents information into contents information suitable for display on any one of various types of communication terminal equipment are distributed among several locations, thereby improving the efficiency in information transfers.

In accordance with an aspect of the present invention, there is provided a communication network system that can provide contents information for users by way of a communication network, the system comprising: a contents server disposed as a source of information, for storing contents information; a portal server, responsive to a request which a user makes through communication terminal equipment, for transmitting contents information to the communication terminal equipment; and a conversion/formatting server disposed between the contents server and the portal server, for converting contents information which the conversion/formatting server has acquired from the contents server into contents information in a predetermined format, formatting the contents information in the predetermined format into contents information suitable for display on the communication terminal equipment in response to a request from the portal server, and transmitting the formatted contents information to the portal server. Accordingly, the above-mentioned aspect of the present invention offers an advantage of being able to distribute functions of the communication network system among several locations, and therefore to improve the efficiency in information transfers.

In accordance with a preferred embodiment of the present invention, in response to a request for information browsing which a user makes through communication terminal equipment, the portal server provides an instruction for transmission of information to be browsed for the conversion/formatting server, and the conversion/formatting server, in response to the information transmitter instruction from the portal server, converts contents information stored in the contents server into contents information in the predetermined format which can be browsed and stores it therein, and formats the contents information in the predetermined format into contents information suitable for display on the communication terminal equipment and transmits the formatted contents information to the portal server.

In accordance with another preferred embodiment of the present invention, in response to a request for information retrieval which a user makes through communication terminal equipment, the portal server provides an instruction for information retrieval for the conversion/formatting server, and the conversion/formatting server, in response to the information retrieval instruction from the portal server, retrieves desired contents information in the predetermined format which is stored therein, and formats the desired contents information in the predetermined format into contents information suitable for display on the communication terminal equipment and transmits the formatted contents information to the portal server.

In accordance with a further preferred embodiment of the present invention, in response to a request for performance of a predetermined process which a user makes through communication terminal equipment, the portal server provides an instruction for the performance of the predetermined process for the conversion/formatting server, and the conversion/formatting server, in response to the instruction for the performance of the predetermined process from the portal server, converts contents information which is stored in the contents server into contents information which corresponds to the instruction for the performance of the predetermined process, and formats the resultant contents information into contents information suitable for display on the communication terminal equipment and transmits the formatted contents information to the portal server.

In accordance with another preferred embodiment of the present invention, in response to a request for performance of a predetermined process which a user makes through communication terminal equipment, the portal server provides an instruction for the performance of the predetermined process for the conversion/formatting server, and the conversion/formatting server, in response to the instruction for the performance of the predetermined process from the portal server, converts contents information which is stored in the contents server into contents information which corresponds to the instruction for the performance of the predetermined process, stores the resultant contents information therein, and formats the resultant contents information into contents information suitable for display on the communication terminal equipment and directly transmits the formatted contents information to the communication terminal equipment according to event information added to the instruction for the performance of the predetermined process. Accordingly, when a user desires contents information, the communication network system can transmit the contents information directly to the user according to event information without imposing a load on the portal server.

In accordance with another preferred embodiment of the present invention, the conversion/formatting server performs a formatting process so as to generate application data which defines a display format in which the communication terminal equipment can display contents information in the predetermined format transmitted thereto, and transmits the application data to the portal server as well as the contents information in the predetermined format.

In accordance with a further preferred embodiment of the present invention, the conversion/formatting server performs a formatting process of formatting the contents information in the predetermined format into contents information which can be displayed on the communication terminal equipment, and transmits the formatted contents information to the portal server. Accordingly, the conversion/formatting server can handle various display format of contents information which are acceptable to various types of communication terminal equipment, respectively, without imposing a load on the portal server. Preferably, the formatting process performed by the conversion/formatting server can be a process of executing an application that defines a display format in which the communication terminal equipment can display the contents information in the predetermined format.

In accordance with another preferred embodiment of the present invention, the communication network is the Internet. Preferably, the communication network can be a radio communication network. As an alternative, the communication network is a wire communication network.

In accordance with a further preferred embodiment of the present invention, the portal server transmits and receives contents information from itself to the communication terminal equipment and vice versa by using E-mail. As an alternative, the portal server can transmit and receive contents information from itself to the communication terminal equipment and vice versa by performing a Web processing.

In addition, in accordance with the present invention, since it is possible to provide a lot of existing contents information, by way of the communication network, for a lot of portal servers as exchangeable contents information, users can access various types of existing contents information by way of many portal servers and therefore the efficiency in the utilization of the communication network in the communication network system can be improved.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing the structure of a communication network system according to a first embodiment of the present invention;

FIG. 2 is a flow chart showing the operation of a communication network system according to a second embodiment of the present invention;

FIG. 3 is a flow chart showing the operation of a communication network system according to a third embodiment of the present invention;

FIG. 4 is a flow chart showing the operation of a communication network system according to a fourth embodiment of the present invention;

FIG. 5 is a flow chart showing the operation of a communication network system according to a fifth embodiment of the present invention; and

FIG. 6 is a block diagram showing the structure of a prior art communication network system.

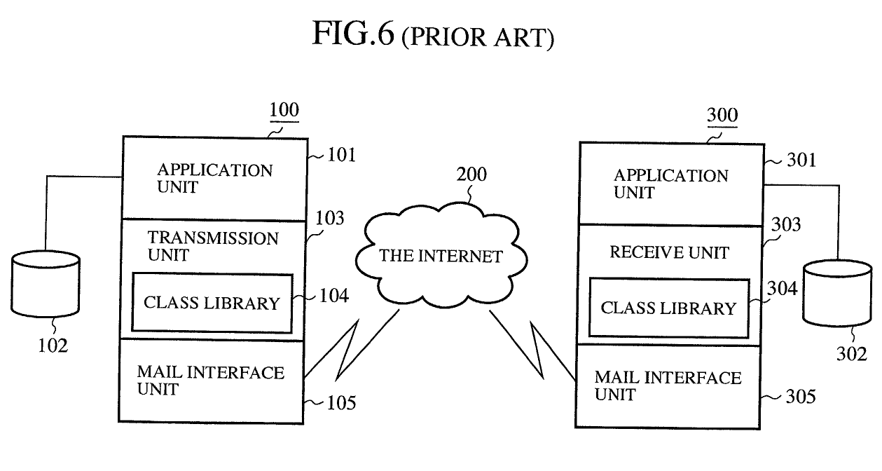

### DETAILED DESCRIPTION OF THE PREFERRED EMBODIMENTS

### Embodiment 1

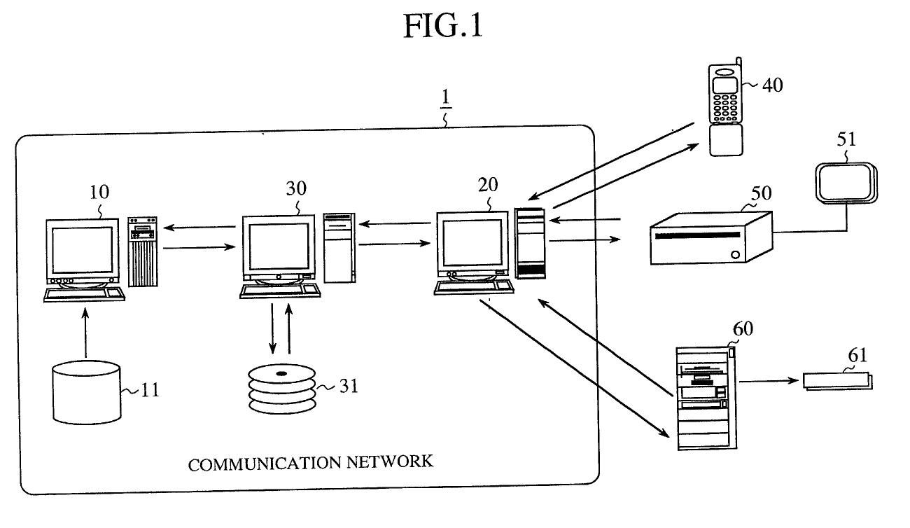

FIG. 1 is a block diagram showing the structure of a communication network system according to a first embodiment of the present invention. In the figure, reference numeral 10 denotes a contents server that reads contents information from a memory 11 in response to a request from outside the contents server and then furnishes it to outside the contents server, reference numeral 20 denotes a portal server that integrates many pieces of contents information which are spread out over a communication network 1, such as the Internet, and constructs a portal site, which can deliver contents information suitable for each user to each user, and reference numeral 30 denotes a conversion/formatting server that reads contents information from the contents server 10 in response to a request from the portal server 20, converts it into contents information in a predetermined format (i.e., having a specific data structure) which can be exchanged by way of the communication network 1 (i.e., which can be distributed by way of the communication network 1), contents information in the predetermined format being referred to as exchangeable contents information from here on, and stores the exchangeable contents information in a storage unit 31, and that formats the exchangeable contents information stored in the storage unit 31 into contents information having a predetermined display format suitable for display on a user's communication terminal equipment and sends it to the portal server 20 which is the source of the request.

The contents server 10, the conversion/formatting server 30, and the portal server 20 are information processing devices such as PCs, which constitute the communication network 1, respectively. The present invention is not limited to the case where the communication network system according to the present invention contains only one contents server 10, only one conversion/formatting server 30, and only one portal server 20. The communication network system according to the present invention can include a plurality of contents servers, a plurality of conversion/formatting servers, and a plurality of portal servers.

Furthermore, reference numeral 40 denotes a cellular phone that is disposed as a piece of communication terminal equipment which can communicate with the portal server 20 or the like by way of the communication network 1, reference numeral 50 denotes a car navigation system that is disposed as a piece of communication terminal equipment which can communicate with the portal server 20 or the like by way of the communication network 1, reference numeral 51 denotes a display that is connected to the car navigation system 50 and displays various pieces of information on car navigation, reference numeral 60 denotes a PC that is disposed as a piece of communication terminal equipment which can communicate with the portal server 20 or the like by way of the communication network 1, and reference numeral 61 denotes a small storage unit, such as a mobile small memory, in which the PC 60 can store information. Communication terminal equipment included in the communication network system according to the present invention is not limited to either of the above-mentioned pieces of communication terminal equipment, and the communication network system can include any one or more pieces of communication terminal equipment that can be connected to the communication network 1 and can communicate with the portal server 20 or the like by way of the communication network 1.

In operation, a user can acquire desired information from many pieces of contents information which are spread out over the communication network 1 by accessing the portal server 20 by way of the communication network 1 using one of a variety of pieces of communication terminal equipment, such as a cellular phone 40, a car navigation system 50 or a PC 60.

As previously mentioned, a plurality of portal servers exist in the communication network 1, and therefore a user can select his or her favorite portal server. Therefore, the portal server 20 should enhance its contents information to have the contents information accessed by a lot of users, and, in order to enhance the contents information, should access a variety of contents servers so as to acquire many pieces of other contents information. The contents server 10 stores contents information having a specific data structure in the storage unit 11. In response to a request from outside the contents server, the contents server 10 can transmit contents information to outside the contents server. When the portal server 20 acquires such contents information directly from the contents server, it has to convert received contents information, which has a data structure specific to the contents server, into exchangeable contents information having a predetermined display format. Conventionally, such format conversion performed in either the portal server 20 or the contents server 10 decreases the efficiency in information transfers for distribution of information, and, consequently, causes the communication network system to become rigid.

In the communication network system according to the first embodiment of the present invention, the conversion/formatting server 30 converts contents information which it has acquired from the contents server 10 into standardized, exchangeable contents information in a predetermined format and then stores it in the storage unit 31. The conversion/formatting server 30 also formats the exchangeable contents information stored in the storage unit 31 into contents information having a predetermined display format suitable for display on a user's communication terminal equipment and sends it to the portal server 20 which is the source of the request for transmission of the contents information.

The portal server 20 can collect many pieces of contents information which are spread out over the communication network 1 according to its purpose associated with what line of business the portal site is in or the like, and can deliver contents information suitable for each user to each user. When the portal server 20 transmits a request for transmission of contents information to the conversion/formatting server 30 in response to a request from a user, the conversion/formatting server 30 reads contents information from the contents server 10 in the way mentioned above and converts it into exchangeable contents information in a predetermined format, and, after that, formats the exchangeable contents information into contents information having a predetermined display format suitable for display on the user's communication terminal equipment and then sends it to the portal server 20 which is the source of the request. The portal server 20 then transmits the received contents information to the user's communication terminal equipment without performing a conversion process on the received contents information. Transmission of information from the portal server 20 to the user's communication terminal equipment and vice versa can be performed by using E-mail. As an alternative, the portal server 20 also serves as a Web server, which constructs a Web site, and transmits and receives information from itself to the user's communication terminal equipment and vice versa by carrying out a Web processing. On the other hand, the user's communication terminal equipment can perform transmission of information between itself and the portal server 20 by using a Web browser which operates on the user's communication terminal equipment.

Instead of transmitting the formatted contents information to the portal server 20, the conversion/formatting server 30 can add application data to the original contents information to be transmitted to the portal server 20 according to a predetermined display format in which the user's communication terminal equipment can display the contents information. In this case, after formatting the contents information to which the application data is added and which has been transmitted from the conversion/formatting server 30 according to the application data, the portal server 20 transmits the formatted contents information to the user's communication terminal equipment. As a result, the communication terminal equipment which has received the formatted contents information can display the formatted contents information on a display thereof. As an alternative, the portal server 20 can simply transmit the contents information to which the application data is added and which has been transmitted from the conversion/formatting server 30 to the user's communication terminal equipment. In this case, the communication terminal equipment can format the received contents information according to the application data and can display the formatted contents information on a display thereof.

Thus, since the conversion/formatting server 30, which is disposed between the contents server 10 and the portal server 20, has conversion and formatting functions of converting contents information into exchangeable contents information in a predetermined format and formatting the contents information into information having a format which can be displayed on a display of communication terminal equipment, the portal server 20 can focus on guiding the user to contents information which the user desires and functions of the communication network system can be distributed among several locations including the conversion/formatting server 30 and the portal server 20, thereby reducing the load of converting contents information into exchangeable contents information in a predetermined format, which is imposed on the portal server 20.

The communication network 1 is not limited to the Internet but can be a radio communication network or a wire communication network. As an alternative, the communication network 1 can be a network like a local network disposed in a specific organization.

As mentioned above, in accordance with the first embodiment of the present invention, the communication network system is so constructed that when a user makes a request for acquisition of contents information or the like by way of a communication network 1, typified by the Internet, the communication network system allows the user to access a portal server 20 using communication terminal equipment such as a cellular phone 40 without directly accessing a contents server 10, and also allows the portal server 20 to, in response to the request for information acquisition or the like from the user, access a conversion/formatting server 30, which is located between the portal server 20 and the contents server 10 and which converts contents information read out of the contents server 10 into contents information which can be exchanged by way of the communication network 1, without directly accessing the contents server 10. Accordingly, the present embodiment offers an advantage of being able to distribute functions of the communication network system among several locations including the conversion/formatting server 30 and the portal server 20, and therefore to improve the efficiency in information transfers.

Furthermore, since the conversion/formatting server 30 performs a formatting process on exchangeable contents information stored in a storage unit 31 so that it can be displayed on a display of any user's communication terminal equipment, the conversion/formatting server 30 can handle various display format of contents information which are acceptable to various types of communication terminal equipment, respectively, without imposing a load on the portal server 20.

In addition, in accordance with the first embodiment of the present invention, since it is possible to provide a lot of existing contents information, by way of the communication network 1, for a lot of portal servers as exchangeable contents information, users can access various types of existing contents information by way of many portal servers and therefore the efficiency in the utilization of the communication network 1 in the communication network system can be improved.

### Embodiment 2

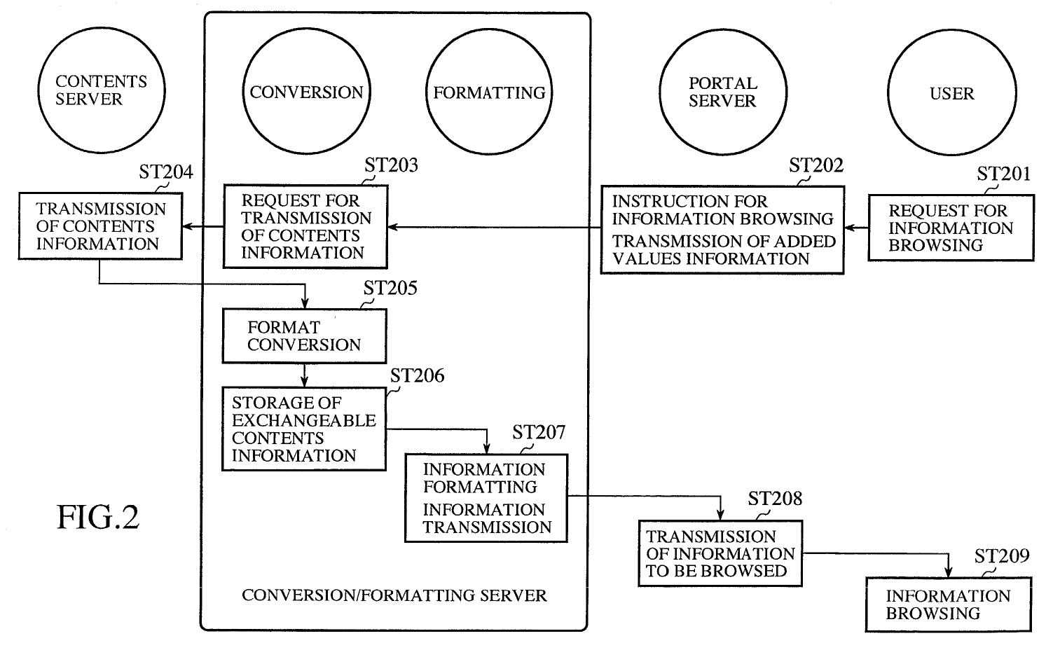

FIG. 2 is a flow chart showing the operation of a communication network system according to a second embodiment of the present invention. The communication network system according to the second embodiment of the present invention has the same structure as that according to the above-mentioned first embodiment shown in FIG. 1, and therefore duplication of the explanation of the structure which is done in the above-mentioned first embodiment will be eliminated hereafter.

A conversion/formatting server 30 of the communication network system according to the second embodiment of the present invention performs conversion and formatting processes on contents information according to an instruction for information browsing which a portal server 20 provides in response to a request for information browsing which a user makes through communication terminal equipment.

In operation, the portal server 20, in step ST202, provides an instruction for information browsing for the conversion/formatting server 30 in response to an request for information browsing which a user makes through communication terminal equipment such as a cellular phone 40 in step ST201. At this time, the portal server 20 can transmit added values information to the conversion/formatting server 30. Added values information is arbitrary information used to guide users to contents information which a portal site intends to provide for users, and is created for purposes of a commercial advertisement or the like. For example, information about “this week's topics”, “special sale”, or “feature”, or top-10 keywords, which are predetermined to narrow contents information specified by a keyword input by a user down to specific meaningful information, are used as added values information. The portal server 20 needs not necessarily transmit added values information to the conversion/formatting server 30, and whether the portal server 20 needs to transmit added values information to the conversion/formatting server 30 depends on what information the user makes a request for browsing on the portal site.

The conversion/formatting server 30, in step ST203, transmits a request for transmission of contents information to the contents server 10 based on added values information transmitted from the portal server 20 according to the information browsing instruction from the portal server 20. The contents server 10, in step ST204, transmits contents information required by the conversion/formatting server 30 in response to the request for transmission of contents information from the conversion/formatting server 30. The conversion/formatting server 30, in step ST205, converts the contents information, which has thus been read out of the contents server, as well as the added values information if necessary, into contents information in a predetermined format, which can be exchanged by way of a communication network 1, and, in step ST206, stores the exchangeable contents information in a storage unit 31.

As previously mentioned, in general, contents information transmitted in step ST204 from the contents server 10 is written in a format which depends on the contents server 10, and the format is different from that of contents information transmitted from any other contents server. Therefore, contents information read out of any contents server cannot be used as information to be browsed which the portal server 20 can provide, just as it is. In a prior art communication network system in which a portal server and a contents server are connected directly to each other, the contents server has to convert contents information to be transmitted into contents information in a format which is the same as that of information to be browsed which the portal server can provide, or the portal server has to perform a format conversion on contents information read out of the contents server so that it has the same format as that of information to be browsed which the portal server can provide. In addition, in a communication network system, in which a lot of portal servers, a lot of contents servers and various types of communication terminal equipment exist, format conversion performed in portal servers or contents servers decreases the efficiency in information transfers for distribution of information, and, consequently, causes the communication network system to become rigid.

In contrast, the conversion/formatting server 30 according to the second embodiment converts contents information read out of the contents server 10, as well as added values information transmitted from the portal server 20 if necessary, into contents information in a predetermined format which can be exchanged by way of the communication network 1, as previously mentioned.

The communication network system has to handle various types of display formats of information which various types of communication terminal equipment provide, respectively. Therefore, the communication network system has to format contents information into information suitable for display on any user's communication terminal equipment.

To transmit contents information in a predetermined display format, which is suitable for display on a user's communication terminal equipment, to the portal server 20, the conversion/formatting server 30, in step ST207, formats the exchangeable contents information stored therein and transmits the formatted contents information to the portal server 20. The portal server 20 then, in step ST208, provides the received, formatted contents information for the user's communication terminal equipment as information which can be browsed, i.e., information to be browsed. As a result, the user can browse the desired contents information through the communication terminal equipment, in step ST209.

The conversion/formatting server 30 formats the exchangeable contents information based on information obtained from the exchangeable contents information according to the instruction from the portal server 20. To this end, the conversion/formatting server 30 adds added values information which is arbitrary information transmitted from the portal server 20 to the contents information if necessary, and subdivides the contents information into some data elements for the next formatting process and then converts it into contents information in a predetermined format which is reusable and exchangeable by way of the communication network 1, without missing any data attributes and any data elements included in the original contents information.

For example, the conversion/formatting server 30 subdivides contents information on the following address element: “Mitsubishi Electric Bldg., 1F, 2-2-3, Marunouchi, Chiyoda-ku, Tokyo-to, Japan” into “Mitsubishi Electric Bldg.”, “1F”, “2”, “2”, “3”, “Marunouchi”, “Chiyoda (ku)”, “Tokyo (to)”, and “Japan”, and then treats the plurality of subdivided data elements, attributes and meanings as “building name”, “floor”, “middle regional unit (aza (section) or chome)”, “small regional unit (banchi (house number))”, “individual unit (gou)”, “large regional unit (ku (district), chou (town), or ooaza (county))”, “small autonomous regional unit (city, ku (district), town, or village)”, “large autonomous regional unit (to (metropolis), dou (a type of prefecture), fu (a type of prefecture), or prefecture)”, and “country”, respectively.

Since the performance of such conversion makes it possible for the conversion/formatting server 30 to determine that another address element: “Mitsubishi Electric Bldg., 10F, 2-2-3, Marunouchi, Chiyoda-ku, Tokyo, Japan” differs from the above-mentioned address element: “Mitsubishi Electric Bldg., 1F, 2-2-3, Marunouchi, Chiyodaku, Tokyo, Japan” in only “floor”, for example, the conversion/formatting server 30 can construct the other address element by using the plurality of data elements other than the floor element, which are obtained by subdividing the above-mentioned address element: “Mitsubishi Electric Bldg., 1F, 2-2-3, Marunouchi, Chiyodaku, Tokyo-to, Japan”, thus improving the reusability of the contents information.

Since each data element to which any exchangeable contents information resulting from conversion of original contents information is subdivided has meaningful contents, it is possible to easily generate contents information having a data structure corresponding to a predetermined display format of the user's communication terminal equipment by formatting the exchangeable contents information.

After formatting exchangeable contents information stored in the storage unit 31 into contents information having a predetermined display format of the user's communication terminal equipment, the conversion/formatting server 30 transmits the formatted contents information to the portal server 20. To be more specific, the conversion/formatting server 30 generates application data from the exchangeable contents information stored in the storage unit 31 based on the predetermined display format of the user's communication terminal equipment according to the instruction from the portal server 20, and then executes an application that formats the exchangeable contents information into contents information having a format which can be displayed on the user's communication terminal equipment according to the application data. In other words, the conversion/formatting server 30 executes an application that defines a display format in which the user's communication terminal equipment can display the exchangeable contents information, which is stored in the storage unit 31.

For example, in the case of the above-mentioned address element: “Mitsubishi Electric Bldg., 1F, 2-2-3, Marunouchi, Chiyoda-ku, Tokyo-to, Japan”, the conversion/formatting server 30 generate application data that turns off the display of “building name”, “floor” “small regional unit (house number)”, and “individual unit (gou)” among the following plurality of data elements which constitute the exchangeable contents information resulting from the conversion of the original contents information and which are stored in the storage unit 31: “Mitsubishi Electric Bldg.”, “1F”, “2”, “2”, “3”, “Marunouchi”, “Chiyoda (ku)”, “Tokyo (to)”, and “Japan”, according to the instruction from the portal server 20. The conversion/formatting server 30 then executes an application that generates contents information which consists only of “2”, “Marunouchi”, “Chiyoda (ku)”, “Tokyo (to)”, and “Japan” according to the application data and transmits the formatted contents information to the portal server 20.

Instead of transmitting the formatted contents information to the portal server 20, the conversion/formatting server 30 can add application data to the contents information to be transmitted to the portal server 20 according to the predetermined display format of the user's communication terminal equipment. In this case, after executing an application that formats the contents information to which the application data transmitted from the conversion/formatting server 30 is added according to the application data, the portal server 20 transmits the formatted contents information to the user's communication terminal equipment. The communication terminal equipment which has received the formatted contents information can display the formatted contents information on a display thereof. As an alternative, the portal server 20 can transmit the contents information to which the application data transmitted from the conversion/formatting server 30 is added to the user's communication terminal equipment. In this case, the communication terminal equipment can format the contents information received according to the application data, and can display the formatted contents information on a display thereof.

For example, in the case of the above-mentioned address element: “Mitsubishi Electric Bldg., 1F, 2-2-3, Marunouchi, Chiyoda-ku, Tokyo-to, Japan”, when communication terminal equipment that inhibits the display of “building name”, “floor”, “small regional unit (house number)”, and “individual unit (gou)”, i.e., “Mitsubishi Electric Bldg., 1F, 2-3” because they are assumed to belong to privacy information makes a request for browsing of the above-mentioned address, the conversion/formatting server 30 transmits contents data which consists of “Mitsubishi Electric Bldg.”, “1F”, “2”, “2”, “3”, “Marunouchi”, “Chiyoda (ku)”, “Tokyo (to)”, and “Japan” to the portal server 20 as exchangeable contents information, as well as application data that turns off the display of “building name”, “floor”, “small regional unit (house number)”, and “individual unit (gou)”. As a result, the user's communication terminal equipment can display the above-mentioned address as “2, Marunouchi, Chiyoda-ku, Tokyo-to, Japan”.

As mentioned above, in accordance with the second embodiment of the present invention, when a user makes a request for information browsing by way of a communication network 1, the communication network system allows the user to access a portal server 20 by using communication terminal equipment such as a cellular phone 40 without directly accessing a contents server 10, and also allows the portal server 20 to, in response to the request for information browsing, access a conversion/formatting server 30 disposed between the portal server 20 and the contents server 10, for converting contents information read out from the contents server 10 into exchangeable contents information and for formatting the exchangeable contents information into contents information which can be displayed on the communication terminal equipment, without directly accessing the contents server 10. Accordingly, the communication network system can distribute its functions among several locations including the conversion/formatting server 30 and the portal server 20 and improve the efficiency in information transfers.

Since the conversion/formatting server 30 can add added values information which is arbitrary information transmitted from the portal server 20 to the contents information if necessary, and can subdivide the contents information into some data elements and convert it into contents information in a predetermined format which can be exchanged by way of the communication network 1, without missing any data attributes and any data elements included in the original contents information, the conversion/formatting server 30 can provide the contents information for the next formatting processing as meaningful, reusable information.

Furthermore, since the conversion/formatting server 30 performs a formatting process on exchangeable contents information to enable the user's communication terminal equipment to display the contents information on a display thereof when the user browses the contents information, the communication network system can support various display formats of exchangeable contents information which are acceptable to various types of communication terminal equipment, respectively, without imposing a load on the portal server 20.

### Embodiment 3

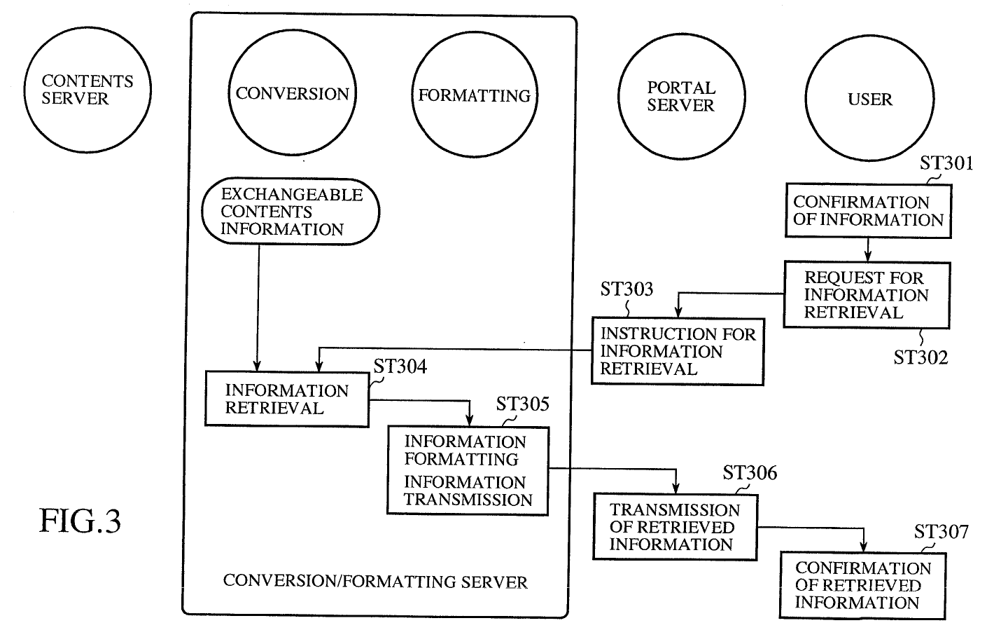

FIG. 3 is a flow chart diagram showing the operation of a communication network system according to a third embodiment of the present invention. The communication network system according to the third embodiment of the present invention has the same structure as that according to the above-mentioned first embodiment shown in FIG. 1, and therefore duplication of the explanation of the structure which is done in the above-mentioned first embodiment will be eliminated hereafter.

A conversion/formatting server 30 of the communication network system according to the third embodiment of the present invention performs conversion and formatting processes on contents information according to an instruction for information retrieval which a portal server 20 provides in response to a request for information retrieval which a user makes through communication terminal equipment.

In operation, when a user, in step ST301, confirms information which has been transmitted from the portal server 20 and which he or she is browsing by using communication terminal equipment, for example, and, in step ST302, makes a request of the portal server 20 for retrieval of contents information to be browsed through the communication terminal equipment, by specifying a retrieval word so as to cause the portal server 20 to search for the desired contents information, the portal server 20 which has received the information retrieval request, in step ST303, instructs the conversion/formatting server 30 to retrieve the desired contents information. The conversion/formatting server 30 which has received the information retrieval instruction, in step ST304, searches through all pieces of exchangeable contents information stored in the storage unit 31 for the desired contents information by using the above-mentioned retrieval word. The exchangeable contents information has been generated by the conversion/formatting server 30 according to the method according to the above-mentioned second embodiment shown in FIG. 2. The conversion/formatting server 30 performs a formatting process on retrieved information resulting from the search and then transmits the retrieved information to the portal server 20, in step ST305. The portal server 20, in step ST306, transmits the retrieved information transmitted from the conversion/formatting server 30 to the user's communication terminal equipment. The communication terminal equipment then, in step ST307, displays the retrieved information received on a display thereof so that the user can confirm the retrieved information through the communication terminal equipment.

Information retrieval needs one or more retrieval words. In the communication network system according to the third embodiment, the conversion/formatting server 30 can add meaningful data attributes into which exchangeable contents information stored in the storage unit 31 is subdivided, or added values information or the like transmitted from the portal server 20 to one or more retrieval words transmitted from the portal server 20 together with the information retrieval instruction. In general, although information retrieval is performed according to the text of each retrieval word, the text of each retrieval word does not specify what meaning, attributes, and elements each retrieval word has and therefore retrieved information might be different from what the user desires. For example, when a portal server in a prior art communication network system performs information retrieval by setting “Marunouchi” as a retrieval word, the portal server searches for “Marunouchi” in “Marunouchi” subway line, and names of enterprise and addresses including “Marunouchi”, and provides a lot of data which contains “Marunouchi” as retrieved information.

In contrast, since the conversion/formatting server 30 according to the third embodiment searches through all pieces of exchangeable contents information stored in the storage unit 31 by using one or more retrieval words as well as corresponding data attributes and added values information or the like which is arbitrary information provided by the portal site, as previously explained in the above-mentioned second embodiment, the conversion/formatting server 30 can perform more accurate information retrieval without missing any data attributes and any data elements included in original contents information stored in the contents server 10.

For example, when performing information retrieval by setting “Marunouchi” as a retrieval word, the conversion/formatting server 30 can obtain “Marunouchi, Chiyoda-ku, Tokyo-to” as retrieved information by adding the following data attributes: “Japan”, “Tokyo (to)”, and “Chiyoda (ku)” to the retrieval word. As an alternative, the conversion/formatting server 30 can obtain “Mitsubishi Electric Bldg., 2-2-3, Marunouchi, Chiyoda-ku, Tokyo-to” as retrieved information by adding “Mitsubishi Electric” to the retrieval word: “Marunouchi” as added values information.

Furthermore, the conversion/formatting server 30 can search through all pieces of exchangeable contents information stored in the storage unit 31 by using only one retrieval word instead of using data attributes and added values information or the like together with one retrieval word, and can provide contents information by adding some data attributes such as “Japan”, “Tokyo (to)”, and “Chiyoda (ku)” to retrieved information and specifying the data attribute of the retrieved information (in the above-mentioned example, the conversion/formatting server 30 can indicate that the data attribute of the retrieved information is an address).

The portal server 20 can be so constructed as to inquire of the user the meaning, attributes, and elements of a retrieval word which is input by the user through the user's communication terminal equipment. In this case, the portal server 20 provides some pieces of narrowing information to narrow the search, which specify data attributes or the like associated with the retrieval word, for the user, allows the user to select one piece of narrowing information from among the plurality of pieces of narrowing information, and transmits the selected piece of narrowing information together with one retrieval word to the conversion/formatting server 30. The conversion/formatting server 30 searches through all pieces of exchangeable contents information stored in the storage unit 31 by using the piece of narrowing information which has been transmitted thereto together with the retrieval word. As a result, as in the above-mentioned case, the conversion/formatting server 30 can perform more accurate information retrieval without missing any data attributes and any data elements included in original contents information stored in the contents server 10.

Since the conversion/formatting server 30 according to the third embodiment performs the formatting process like that according to the above-mentioned second embodiment, the explanation of the formatting process will be omitted hereafter.

As mentioned above, in accordance with the third embodiment of the present invention, the communication network system is so constructed that when a user makes a request for information retrieval by way of a communication network 1, typified by the Internet, the communication network system allows the user to access a portal server 20 using communication terminal equipment such as a cellular phone 40 without directly accessing a contents server 10, and also allows the portal server 20, in response to the request for information retrieval from the user, to access a conversion/formatting server 30, which is located between the portal server 20 and the contents server 10 and which converts contents information read out of the contents server 10 into exchangeable contents information and performs a formatting process on the exchangeable contents information without directly accessing the contents server 10. Accordingly, the present embodiment offers an advantage of being able to distribute functions of the communication network system among several locations and therefore to improve the efficiency in information transfers.

Furthermore, since when a user makes a request for information retrieval the conversion/formatting server 30 performs a formatting process on desired exchangeable contents information so that it can be displayed on the user's communication terminal equipment, the conversion/formatting server 30 can support various display formats of contents information which are acceptable to various types of communication terminal equipment, respectively, without imposing a load on the portal server 20.

### Embodiment 4

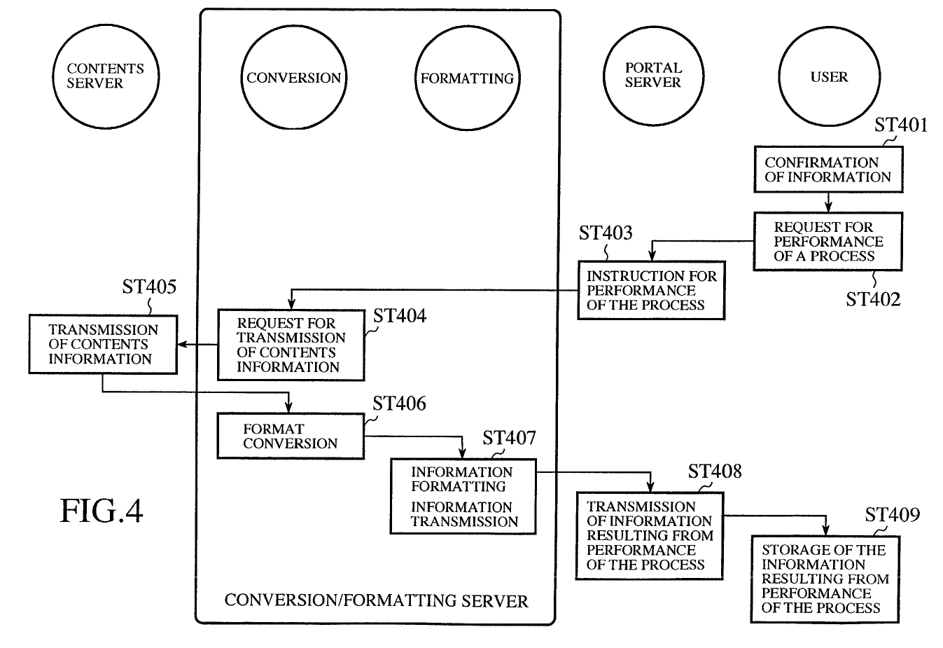

FIG. 4 is a flow chart diagram showing the operation of a communication network system according to a fourth embodiment of the present invention. The communication network system according to the fourth embodiment of the present invention has the same structure as that according to the above-mentioned first embodiment shown in FIG. 1, and therefore duplication of the explanation of the structure which is done in the above-mentioned first embodiment will be eliminated hereafter.

A conversion/formatting server 30 of the communication network system according to the fourth embodiment of the present invention acquires contents information from a contents server 10 and performs conversion and formatting processes on the contents information according to an instruction for the performance of a predetermined process, such as confirmation of a reservation, an order, or a location (destination), which a portal server 20 provides in response to a request for the performance of the predetermined process which a user makes through communication terminal equipment. The conversion/formatting server 30 according to the fourth embodiment can perform a formatting process like that according to the above-mentioned second embodiment.

In operation, when a user, in step ST401, confirms information through information retrieval or the like performed according to the method shown in the above-mentioned third embodiment, he or she can make a request of the portal server 20 for the performance of a predetermined process, such as confirmation of a reservation, an order, or a location, through the user's communication terminal equipment, in step ST402. The portal server 20 then, in step ST403, provides an instruction for the performance of the predetermined process for the conversion/formatting server 30 in response to the request for the performance of the predetermined process from the communication terminal equipment. The conversion/formatting server 30 which has received the instruction for the performance of the predetermined process, in step ST404, makes a request of the contents server 10 for transmission of corresponding contents information. The contents server 10 which has received the request for transmission of corresponding contents information, in step ST405, transmits required contents information to the conversion/formatting server 30. The conversion/formatting server 30, in step ST406, converts the contents information which has thus been read out of the contents server 10 into contents information in a predetermined format which can be exchanged by way of a communication network 1, and then, in step ST407, performs a formatting process on the contents information and transmits the formatted contents information to the portal server 20 as a result of the performance of the predetermined process. The portal server 20 which has received the result of the performance of the predetermined process transmitted from the conversion/formatting server 30, in step ST408, further transmits the information to the user's communication terminal equipment. The communication terminal equipment then, in step ST409, can perform a predetermined process on the received result of the performance of the predetermined process, such as display of the result on a display thereof, as well as storage of the result in a storage unit thereof or the like, so that the user can confirm the result through the communication terminal equipment.

Like the above-mentioned second embodiment, instead of transmitting the formatted contents information to the portal server 20, the conversion/formatting server 30 can add application data to the contents information to be transmitted to the portal server 20 according to the predetermined display format of the user's communication terminal equipment. In this case, after executing an application that formats the contents information to which the application data transmitted from the conversion/formatting server 30 is added according to the application data, the portal server 20 transmits the formatted contents information to the user's communication terminal equipment. The communication terminal equipment which has received the formatted contents information can display the formatted contents information on a display thereof. As an alternative, the portal server 20 can transmit the contents information to which the application data transmitted from the conversion/formatting server 30 is added to the user's communication terminal equipment. In this case, the communication terminal equipment can format the contents information received according to the application data, and can display the formatted contents information on a display thereof.

When a user confirms a location through communication terminal equipment, for example, the portal server 20 can finally provide map data corresponding to the location confirmation request for the user, but cannot acquire the corresponding map data only by receiving data on the address of the location. When the conversion/formatting server 30 according to the fourth embodiment receives an instruction for transmission of map data which the portal server 20 provides in response to a request for confirmation of a location from a user, it converts received address data into data on latitude and longitude, and makes a request of the contents server 10 for transmission of map data which contains the latitude and longitude. The conversion/formatting server 30 then converts and formats the map data obtained from the contents server 10 into drawing data which can be displayed by the user's communication terminal equipment, and transmits the drawing data to the portal server 20.

To this end, the conversion/formatting server 30 subdivides each address data into the following plural data elements: “building name”, “floor”, “middle regional unit (section or chome)”, “small regional unit (house number)”, “individual unit (gou)”, “large regional unit (ku (district), chou (town), or ooaza (county)”, “small autonomous regional unit (city, ku (district), town, or village)”, “large autonomous regional unit (to (metropolis), dou (a type of prefecture), fu (a type of prefecture), or prefecture)”, and “country”, and stores each address data in the storage unit 31 as the set of data elements. In addition, the conversion/formatting server 30 stores data on the latitude and longitude of a typical location within an area specified by each data element. As a result, the conversion/formatting server 30 can easily convert any address data transmitted from the portal server 20 into data on latitude and longitude.

For example, as for Japan which is an element which belongs to “Country”, the conversion/formatting server 30 stores data on the latitude and longitude of National Diet. As for each administrative division which is an element which belongs to “large autonomous regional unit (to (metropolis), dou (a type of prefecture), fu (a type of prefecture), or prefecture)”, the conversion/formatting server 30 stores data on the latitude and longitude of the seat of the prefectural government. In this case, since as for a range of latitudes and a range of longitudes which each of a plurality of data elements, into which each address data is subdivided as mentioned above, actually has, the following relationship: “country”>“large autonomous regional unit (to (metropolis), dou (a type of prefecture), fu (a type of prefecture), or prefecture)”>“small autonomous regional unit (city, district, town, or village)”>“large regional unit (ku (district), chou (town), or county)”>“middle regional unit (section or chome)”>“small regional unit (house number)”>“individual unit (gou)”>“building name” is established, the latitude and longitude data that are determined as mentioned above also has a tree structure. Address element data having such a tree structure and latitude and longitude data having such a tree structure can be easily constructed. The tree structure has an advantage that no overlap exists in any address data that is generated based on a plurality of address element data which are thus subdivided like a tree since there is no overlap in those address element data. It is also possible to generate and display 3-D map data by defining data on height as “floor”.

As mentioned above, in accordance with the fourth embodiment of the present invention, the communication network system is so constructed that when a user makes a request for the performance of a predetermined process, such as confirmation of a reservation, an order, or a location, by way of a communication network 1, typified by the Internet, the communication network system allows the user to access a portal server 20 using communication terminal equipment such as a cellular phone 40 without directly accessing a contents server 10, and also allows the portal server 20, in response to the request for the performance of the predetermined process from the user, to access a conversion/formatting server 30, which is located between the portal server 20 and the contents server 10 and which converts contents information read out of the contents server 10 into exchangeable contents information, and performs a formatting process on the exchangeable contents information without directly accessing the contents server 10. Accordingly, the present embodiment offers an advantage of being able to distribute functions of the communication network system among several locations and therefore to improve the efficiency in information transfers.

Furthermore, since when a user makes a request for the performance of a process the conversion/formatting server 30 performs a formatting process on exchangeable contents information so that it can be displayed on a display of the user's communication terminal equipment, the conversion/formatting server 30 can support various display formats of contents information which are acceptable to various types of communication terminal equipment, respectively, without imposing a load on the portal server 20.

### Embodiment 5

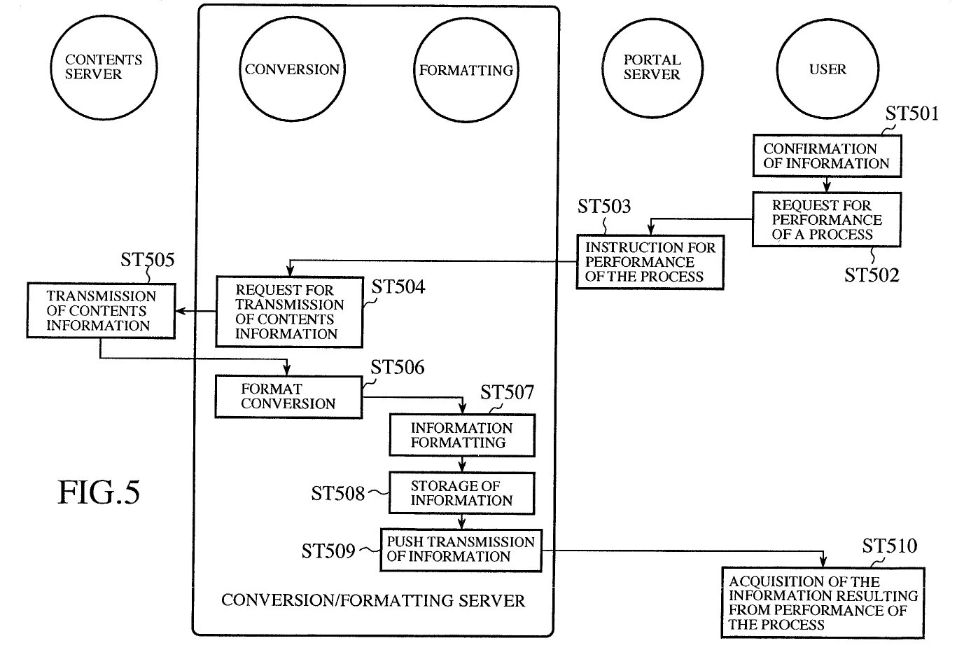

FIG. 5 is a flow chart diagram showing the operation of a communication network system according to a fifth embodiment of the present invention. The communication network system according to the fifth embodiment of the present invention has the same structure as that according to the above-mentioned first embodiment shown in FIG. 1, and therefore duplication of the explanation of the structure which is done in the above-mentioned first embodiment will be eliminated hereafter.

A conversion/formatting server 30 of the communication network system according to the fifth embodiment of the present invention acquires contents information from a contents server 10 and performs conversion and formatting processes on the contents information according to an instruction for the performance of a predetermined process, such as confirmation of a reservation, an order, or a location (destination), which a portal server 20 provides in response to a request for the performance of the predetermined process which a user makes through communication terminal equipment. The conversion/formatting server 30 then push-transmits the conversion-processed and formatted contents information directly to the user's communication terminal equipment according to event information. The conversion/formatting server 30 according to the fifth embodiment can perform a formatting process like that according to the above-mentioned second embodiment.

In operation, when a user, in step ST501, confirms information through information retrieval or the like performed according to the method shown in the above-mentioned third embodiment, he or she can make a request of the portal server 20 for the performance of a predetermined process, such as confirmation of a reservation, an order, or a location, through the user's communication terminal equipment, in step ST502. The portal server 20 then, in step ST503, provides an instruction for the performance of the predetermined process for the conversion/formatting server 30 in response to the request for the performance of the predetermined process from the communication terminal equipment. The conversion/formatting server 30 which has received the instruction for the performance of the predetermined process, in step ST504, makes a request of the contents server 10 for transmission of corresponding contents information. The contents server 10 which has received the request for transmission of corresponding contents information, in step ST505, transmits required contents information to the conversion/formatting server 30. The conversion/formatting server 30, in step ST506, converts the contents information which has thus been read out of the contents server 10 into contents information in a predetermined format which can be exchanged by way of a communication network 1, and then, in step ST507, performs a formatting process on the contents information and, in step ST508, stores the formatted contents information in a storage unit 31 as a result of the performance of the predetermined process. After that, the conversion/formatting server 30, in step ST509, push-transmits the result of the performance of the predetermined process directly to the user's communication terminal equipment at a date and time specified by event information which is stored in the storage unit 31 in the same way that the formatted contents information is stored. The communication terminal equipment then, in step ST510, can perform a certain process on the received result of the performance of the predetermined process, such as display of the result on a display thereof, as well as storage of the result in a storage unit thereof or the like, so that the user can confirm the result through the communication terminal equipment.

Like the above-mentioned second embodiment, instead of transmitting the formatted contents information to the portal server 20, the conversion/formatting server 30 can add application data to the contents information to be transmitted to the portal server 20 according to the predetermined display format of the user's communication terminal equipment. In this case, the communication terminal equipment can format the contents information received according to the application data, and can display the formatted contents information on a display thereof.

For example, when a user makes a request for transmission at a certain date and time of map data, which is specified by the following address data: “Mitsubishi Electric Bldg., 1F, 2-2-3, Marunouchi, Chiyoda-ku, Tokyoto, Japan”, according to a schedule, such as a meeting schedule, through communication terminal equipment, the conversion/formatting server 30 deliver the specified map data, which has been stored in the storage unit 31 in advance according to the above-mentioned procedure, directly to the user's communication terminal equipment at the preset date and time.

As mentioned above, in accordance with the fifth embodiment of the present invention, the communication network system is so constructed that when a user makes a request for the performance of a predetermined process, such as confirmation of a reservation, an order, or a location, by way of a communication network 1, typified by the Internet, the communication network system allows the user to access a portal server 20 using communication terminal equipment such as a cellular phone 40 without directly accessing a contents server 10, and also allows the portal server 20, in response to the request for the performance of the predetermined process from the user, to access a conversion/formatting server 30, which is located between the portal server 20 and the contents server 10, and which converts contents information read out of the contents server 10 into exchangeable contents information, and performs a formatting process on the exchangeable contents information without directly accessing the contents server 10, and the conversion/formatting server 30 transmits the formatted contents information directly to the user's communication terminal equipment according to event information. Accordingly, the present embodiment offers an advantage of being able to distribute functions of the communication network system among several locations and therefore to improve the efficiency in information transfers. The present embodiment offers another advantage of being able to transmit contents information directly to the user when the user needs the contents information without imposing a load on the portal server 20.

Furthermore, since when a user makes a request for the performance of a process the conversion/formatting server 30 performs a formatting process on exchangeable contents information so that it can be displayed on the user's communication terminal equipment, the conversion/formatting server 30 can support various display formats of contents information which are acceptable to various types of communication terminal equipment, respectively, without imposing a load on the portal server 20.

Many widely different embodiments of the present invention may be constructed without departing from the spirit and scope of the present invention. It should be understood that the present invention is not limited to the specific embodiments described in the specification, except as defined in the appended claims.

What is claimed is:

1. A communication network system that can provide contents information for users by way of a communication network, said system comprising:
a contents server disposed as a source of information, for storing contents information;
a portal server, responsive to a request which a user makes through communication terminal equipment, for transmitting contents information to the communication terminal equipment; and
a conversion/formatting server disposed between said contents server and said portal server, for converting contents information which said conversion/formatting server has acquired from said contents server into contents information in a predetermined format, formatting the contents information in the predetermined format into contents information suitable for display on the communication terminal equipment in response to a request from said portal server, and transmitting the formatted contents information to said portal server.

2. The communication network system according to claim 1, wherein in response to a request for information browsing which a user makes through communication terminal equipment, said portal server provides an instruction for transmission of information to be browsed for said conversion/formatting server, and said conversion/formatting server, in response to the information transmitter instruction from said portal server, converts contents information stored in said contents server into contents information in the predetermined format which can be browsed and stores it therein, and formats the contents information in the predetermined format into contents information suitable for display on the communication terminal equipment and transmits the formatted contents information to said portal server.

3. The communication network system according to claim 2, wherein in response to a request for information retrieval which a user makes through communication terminal equipment, said portal server provides an instruction for information retrieval for said conversion/formatting server, and said conversion/formatting server, in response to the information retrieval instruction from said portal server, retrieves desired contents information in the predetermined format which is stored therein, and formats the desired contents information in the predetermined format into contents information suitable for display on the communication terminal equipment and transmits the formatted contents information to said portal server.

4. The communication network system according to claim 1, wherein in response to a request for performance of a predetermined process which a user makes through communication terminal equipment, said portal server provides an instruction for the performance of the predetermined process for said conversion/formatting server, and said conversion/formatting server, in response to the instruction for the performance of the predetermined process from said portal server, converts contents information which is stored in said contents server into contents information which corresponds to the instruction for the performance of the predetermined process, and formats the resultant contents information into contents information suitable for display on the communication terminal equipment and transmits the formatted contents information to said portal server.

5. The communication network system according to claim 1, wherein in response to a request for performance of a predetermined process which a user makes through communication terminal equipment, said portal server provides an instruction for the performance of the predetermined process for said conversion/formatting server, and said conversion/formatting server, in response to the instruction for the performance of the predetermined process from said portal server, converts contents information which is stored in said contents server into contents information which corresponds to the instruction for the performance of the predetermined process, stores the resultant contents information therein, and formats the resultant contents information into contents information suitable for display on the communication terminal equipment and directly transmits the formatted contents information to the communication terminal equipment according to event information added to the instruction for the performance of the predetermined process.

6. The communication network system according to claim 1, wherein said conversion/formatting server performs a formatting process so as to generate application data which defines a display format in which the communication terminal equipment can display contents information in the predetermined format transmitted thereto, and transmits the application data to said portal server as well as the contents information in the predetermined format.

7. The communication network system according to claim 1, wherein said conversion/formatting server performs a formatting process of formatting the contents information in the predetermined format into contents information which can be displayed on the communication terminal equipment, and transmits the formatted contents information to said portal server.

8. The communication network system according to claim 7, wherein the formatting process performed by said conversion/formatting server is a process of executing an application that defines a display format in which the communication terminal equipment can display the contents information in the predetermined format.

9. The communication network system according to claim 1, wherein said communication network is the Internet.

10. The communication network system according to claim 1, wherein said communication network is a radio communication network.

11. The communication network system according to claim 1, wherein said communication network is a wire communication network.

12. The communication network system according to claim 1, wherein said portal server transmits and receives contents information from itself to the communication terminal equipment and vice versa by using E-mail.

13. The communication network system according to claim 1, wherein said portal server transmits and receives contents information from itself to the communication terminal equipment and vice versa by performing a Web processing.
